(19) United States
(12) Patent Application Publication
(10) Pub. No.: US 2004/0155856 A1
(43) Pub. Date: Aug. 12, 2004

(54) Sequential color illumination in display systems employing light modulators

(76) Inventors: Peter Richards, Menlo Park, CA (US); Andrew Huibers, Palo Alto, CA (US); Michel Combes, Santa Cruz, CA (US)

Correspondence Address: REFLECTIVITY, INC., 350 POTRERO AVENUE, SUNNYVALE, CA, 94085, US

(21) Appl. No.: 10/771,231

(22) Filed: Feb. 3, 2004

Related U.S. Application Data
(63) Continuation-in-part of application No. 10/052,012, filed on Jan. 16, 2002, now Pat. No. 6,726,333.

(51) Int. Cl. G09G 3/36

(52) U.S. Cl. 345/102

(57) ABSTRACT

The present invention provides an illumination system for providing sequential colour light beams for display systems employing light modulators. The illumination system comprises a light source, a lightpipe, and a colour filter that is positioned after the lightpipe on the propagation path of the illumination light such that primary colour light beams shining on the light modulator have defined boundaries during colour transition periods.

### TECHNICAL FIELD OF THE INVENTION

The present invention is related generally to display systems employing light modulators, and, more particularly, to apparatus and method of sequential colour illumination in the display systems.

### BACKGROUND OF THE INVENTION

In display systems employing light modulators, such as liquid-crystal-display (LCD), liquid-crystal-on-silicon (LCOS), and microelectromechanical system (MEMS)-based display systems, colour images are often produced using sequential-colour techniques, in which primary colour (red, green, and blue) light are sequentially applied to the light modulator. The pixels of the light modulator modulate the primary colour light with image data corresponding to the primary colour being modulated so as to generate a colour component of the desired image. In sequential colour applications, colour filters, such as colour wheels, are generally used. A colour wheel may have many segments each of which passes light of a particular waveband, such as red light, or green light or blue light. By directing a beam of light onto a colour wheel that spins around a shaft, primary colour light beams are sequentially produced.

In accordance with such produced primary colours, a colour image is represented by sets of image data with each set representing a primary colour component of the image. During a time interval when the pixels of the light modulator are illuminated by a primary colour (e.g. red), image data for the primary colour (e.g. image data for the red colour) is written to the pixels of the light modulator so as to produce the primary colour component of the image. The image data can be written in many ways, such as a pulse-width-modulation scheme. During a frame period, all three primary colour components of the image are produced and integrated together by human eyes so as to produce the image.

In such colour light sequence, however, there are time intervals during which a combination of the primary colours (e.g. red and green, or green and blue, or blue and red) is incident on areas of the pixels of the light modulator simultaneously. This occurs when the spokes of the colour wheel pass through the output of either the arc lamp (when the colour wheel is positioned immediately after the arc lamp) or a lightpipe (when the lightpipe is positioned between the arc lamp and colour wheel). This phenomenon is often referred to as “colour transition”. The time interval that a spoke sweeps across the output of the arc lamp or the lightpipe, or equivalently, the time interval that all pixels of the light modulator experience the colour transition once is often referred to as “colour transition period”. In current display systems, the primary colours illuminating the pixels of the light modulator during the colour transition period are either dumped or used as components of white colour for high brightness or a combined secondary colour. In the situation where the primary colours are dumped, optical efficiency of the display system is degraded. In the situation when the spoke light beams are used as components of white colour, colour saturation of the image is sacrificed.

Therefore, what is needed is a sequential illumination method and apparatus for illuminating light modulators of display systems. With the method and apparatus disclosed herein the vast majority of sequential colour light beams can be utilized without sacrificing the colour saturation of the images to be displayed.

### SUMMARY OF THE INVENTION

In an embodiment of the invention, a display system is provided, comprising: a light source providing light; a lightpipe positioned in the propagation path of the light; a colour wheel comprising a set of colour filtering segments and being positioned in the propagation path and after the lightpipe, said segments being sized such that at most two different colours are incident on a set of pixels of a light modulator at a time; and wherein the light modulator is positioned in the propagation path and modulating the light so as to produce an image.

In another embodiment of the invention, a method of displaying an image is disclosed. The method comprises: emitting light from a light source; a lightpipe collecting the light and projecting the collected light onto a set of colour filtering segments of a colour wheel so as to illuminate an area on the colour wheel, wherein each said segment being sized such that at most one boundary of adjacent segments appears in the illuminated area on the colour wheel at a time; illuminating an array of pixels of a light modulator with the light passing through the segments of the colour wheel such that at most two colours are incident on the pixel array; and modulating the colours with the pixels of the pixel array with corresponding image data.

In yet another embodiment of the invention, an illumination system for illuminating a light modulator having an array of pixels of a display system is provided. The system comprises: a light source providing light; a lightpipe for collecting the light and projecting the collected light onto a colour wheel that comprises 12 or fewer colour filtering segments with radially extending borders between the segments; and wherein the colour wheel is positioned between the light modulator and the lightpipe.

In yet another embodiment of the invention, an illumination system for illuminating a light modulator having an array of pixels of a display system is disclosed. The system comprises: a light source providing light; a lightpipe for collecting the light and projecting the collected light onto a colour wheel that comprises a set of colour filtering segments, each said segment having an edge along a radius of the colour wheel; and wherein the colour wheel is positioned between the light modulator and the lightpipe.

In yet another embodiment of the invention, a method of displaying an image using a light modulator that comprises an array of pixels is disclosed. The method comprises: illuminating the array of pixels with a sequence of coloured light, wherein at most two colours are present on the pixel array in a first colour area and a second colour area at a time; and modulating the coloured light with the pixels such that within a row at least one pixel is within the first colour area and modulates light of a first colour, and a second pixel is within the second colour area and modulates light of the second colour, and a third pixel is positioned between the first and second pixels and modulate light in way different from the first and second pixels.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 schematically illustrates a display system in which embodiments of the invention can be implemented;

FIG. 2A illustrates an exemplary colour wheel that can be used in the display system of FIG. 1;

FIG. 2B illustrates another exemplary colour wheel that can be used in the display system of FIG. 1;

FIG. 2C illustrates yet another exemplary colour wheel that can be used in the display system of FIG. 1

FIG. 2D illustrates a illumination scheme of the pixels of the light modulator during a colour transition period;

FIG. 2E is an exploded diagram schematically illustrating the pixel that are illuminated by a combination of red and green primary colours; and

FIG. 3 schematically illustrates an exemplary illumination scheme of the light modulator, based on which a light modulation method according to the invention can be implemented.

### DETAILED DESCRIPTION OF THE INVENTION

The present invention provides an illumination system for providing sequential colour light beams. The illumination system comprises a light source, a lightpipe, and a colour filter that is positioned after the lightpipe within the propagation path of the illumination light such that primary colour light beams shining on the light modulator have defined boundaries during colour transition periods.

In operation, a frame period is divided into primary colour periods and colour transition periods, each colour transition period further comprising a set of spoke periods. During a primary colour period, the pixels of the light modulator are illuminated by one primary colour. During a colour transition period, the pixels of the light modulator are sequentially illuminated by a combination of the primary colours. Because the combination of the primary colours has a defined boundary when illuminating the pixels of the light modulator, such a boundary sequentially sweeps across the rows of the pixel array of the light modulator during a colour transition period. Accordingly, a spoke period is defined for a row of pixels as the time interval that the row of pixels is swept by a spoke. The spoke periods within a colour transition period vary with the position of the rows. Specifically, the spoke periods within a colour transition period for different rows start and end at different times, and the duration of the spoke periods may change with the rows.

During a primary colour period, the pixels of the light modulator modulate the primary colour light beam with image data corresponding to the primary colour. During a colour transition period when a combination of primary colours is incident on the array of the light modulator, the rows of pixels not in their spoke periods respectively modulate the primary colours of the combination; while the rows of pixels in their spoke period are set to the OFF state.

In the following, the present invention will be discussed by way of specific examples. Those skilled in the art will certainly appreciate that the following discussion is for demonstration purposes only and should not be interpreted as a limitation on the scope of the invention.

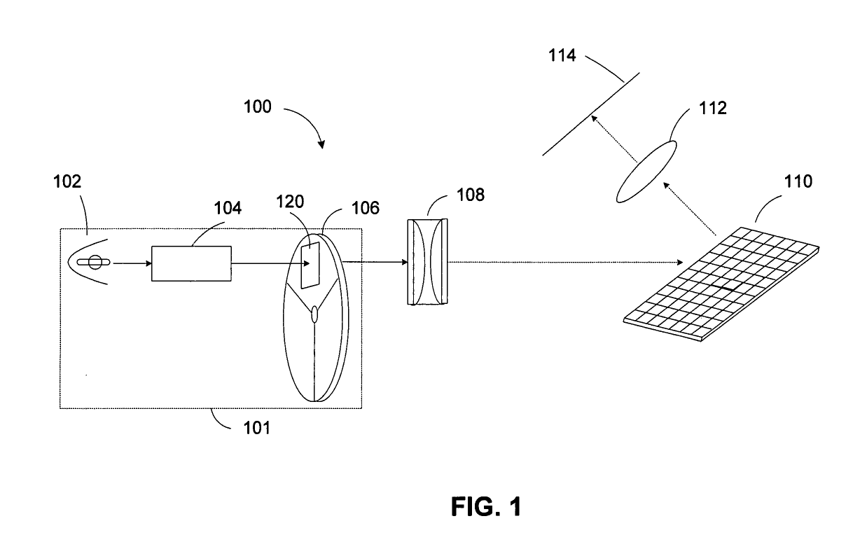

Referring to FIG. 1, an exemplary display system is illustrated. In its basic configuration, display system 100 comprises illumination system 101 for producing sequential colour light, light modulator 110, projection lens 112, and display target 114. Other optics, such as condensing lens 108 could also be installed if desired.

Illumination system 101 comprises light source 102, which can be an arc lamp, lightpipe 104 that can be any suitable integrator of light or light beam shape changer, and colour filter 106, which can be a colour wheel. It is worthwhile to point out that the colour wheel is positioned after the light source and lightpipe on the propagation path of the illumination light from the light source.

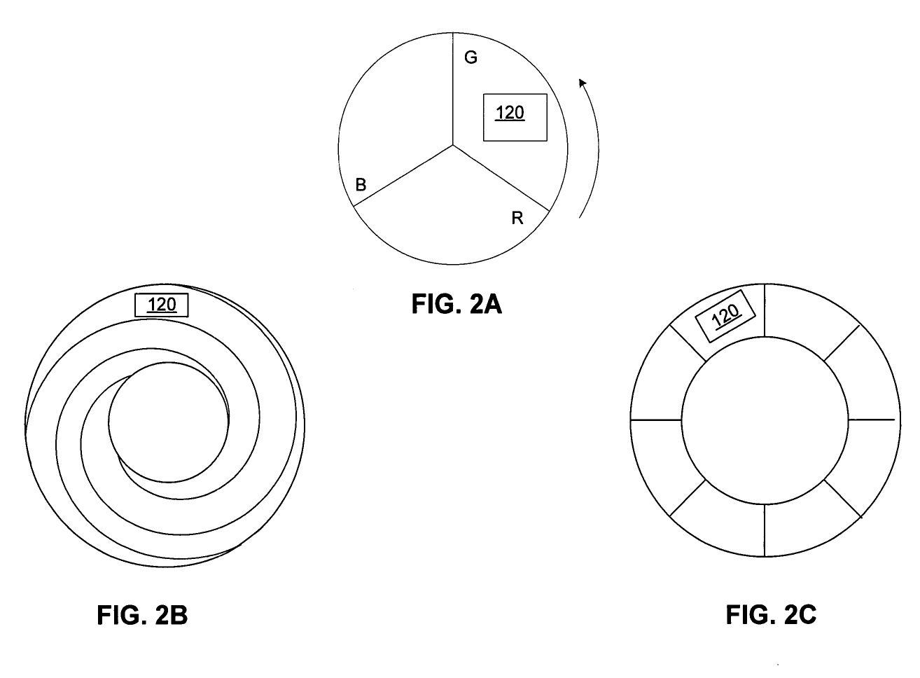

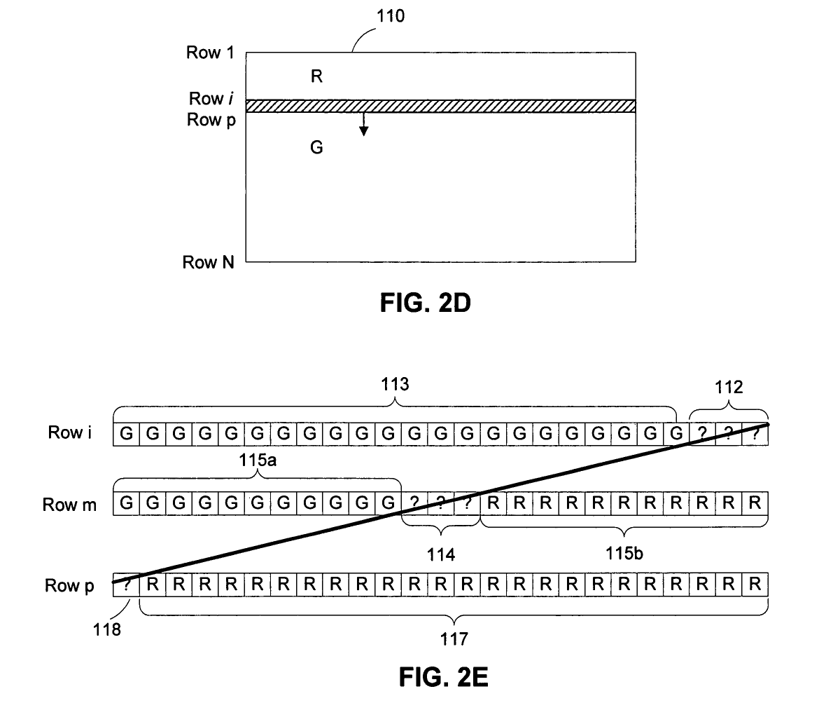

The colour wheel can be of many different configurations, one of which is illustrated in FIG. 2A. Referring to FIG. 2A, the colour wheel in this particular example comprises three segments R, G, and B. Each segment passes light of a particular waveband. Specifically, the R segment passes red light; the G segment passes green light; and the B segment passes blue light. In another example, the colour wheel may comprise more than three segments, such as a white segment can be provided in addition to the R, G, and B segments. In yet another example, instead of having only one segment for one of the three primary colours, the colour wheel may have a plurality of segments for a primary colour (e.g. RGBRGB or RGBRGBRGB), in which situation, the total number of segments is preferably less than 40, more preferably less than 30, more preferably less than 24, such as 12 or fewer. When multiple segments are provided for the same primary colour, the multiple segments may not be uniformly distributed. For example, the areas of the multiple segments for the same primary colour can be different. Rather than the three primary colours—red, green, and blue, the segments of the colour wheel may be designed for passing other colour combinations. For example, the colour wheel may have segments that respectively pass yellow, cyan, and magenta (or both red, green, and blue, as well as yellow, cyan and magenta).

FIG. 2B schematically illustrates another exemplary colour wheel. The spokes of the colour wheel have spiral shapes, such as the Archimedean spiral. The primary colours; or selected colours (e.g. yellow, cyan, and magenta) are distributed between the spiral spokes. FIG. 2C schematically illustrates yet another exemplary colour wheel that can be used in the present invention. The colour wheel ring has many segments in which the primary colours or selected colours (e.g. yellow, cyan, and magenta) are distributed.

The light beam from the output opening of lightpipe 104 illuminates only a portion of the colour wheel, as shown in FIG. 1. The illumination area on the colour wheel is illustrated by window 120 in FIGS. 2A, 2B, and 2C. As an example of the invention, illumination area 120 has a size that is smaller than the area of any segment of the colour wheel or a length of a colour wheel segment is not less than half, preferably not less than the entire length (or width) of the pixel array of the light modulator (whichever corresponds to the columns of the array). As a result, the light from the lightpipe illuminates at most two segments at a time as the colour spins around its shaft in operation.

The light modulator may comprise an array of microscopic mirrors (these can be any size, though generally less than 20 micrometers in length), as set forth in U.S. Pat. Nos. 6,046,840 and 6,172,797; and U.S. patent application Ser. No. 10/366,296 to Patel, filed Feb. 12, 2003; Ser. No. 10/366,297 to Patel, filed Feb. 12, 2003; Ser. No. 10/627,155 to Patel, filed Jul. 24, 2003; Ser. No. 10/613,379 to Patel, filed Jul. 3, 2003; Ser. No. 10/437,776 to Patel, filed May 13, 2003; and Ser. No. 10/698,563 to Patel, filed Oct. 30, 2003, the subject matter of each being incorporated herein by reference. The light modulator may also be transmissive liquid crystal type display, reflective liquid crystal type display or another type of light modulator. Upon receiving the sequential colour light beams, the pixels of the light modulator individually modulates the light beams with the image data so as to generate the image on the display target. Specifically, each pixel operates in an ON and OFF state. A light beam is reflected by a pixel towards projection lens 112 in FIG. 1 so as to create a “bright” pixel in display target 114 when the pixel is in the ON state. In the OFF state, the pixel reflects the light away from the projection lens so as to create a “dark” pixel in the display target. Operation of the pixels is controlled by electrodes and memory cells of the pixels. In addition to digitally operated light modulators, the light modulator can also be analog light modulators, such as analog mirror array, transmissive liquid crystal type display or analog reflective liquid crystal type display.

The sequential primary colour light beams from the colour wheel sequentially illuminate the pixels of the light modulator during a frame period. When the illumination area (e.g. illumination area 120 in FIGS. 1 and 2A) is within a segment of a primary colour, the pixels of the pixel array in the light modulator are illuminated with the primary colour. As the colour wheel spins during operation, the illumination area sweeps across different segments of the colour wheel, resulting in colour variation of the light shining on the pixels of the light modulator, as shown in FIG. 2D.

Referring to FIG. 2D, an illumination scheme of the pixel array of the light modulator at a particular time is illustrated therein. At the particular time, the spoke between the G and R segments of the colour wheel lies within illumination area 120 of the colour wheel. Because the colour wheel is positioned behind the light pipe, the green and red colour beams on the light modulator present a boundary. As a result, pixels of the rows from 1 to i of the array are illuminated by the red colour light. Rows from i to p are illuminated by a combination of red and green colour light beams. The number of rows between the rows i and p is determined, among other factors, by the segment and the illumination area. Pixels of the rows from p to N (wherein the pixel array of the light modulator is assumed to have total number of N rows) are illuminated with the green colour light. As the colour wheel spins, the pixel rows are sequentially illuminated by the combination of green and red colour light. As a way of example, the illumination scheme of the pixel rows from i to p is illustrated in FIG. 2E.

Referring to FIG. 2E, the pixels of the rows from i to p are illuminated by red and green colours simultaneously, wherein the boundary of the red and green colours is represented by the solid line that spans across the rows from i to p. Pixels of row i are illuminated by green colours except pixels 112 of the row. The colour of the illumination light on pixels 112 is undeterminable due to many facts, such as the fact that the red and green colour light beams may be mixed from light scattering in these pixels. For the same reason, the colour of the illumination light on pixels 114 in row m is undeterminable. The pixels on the left side of pixels 114 in row m are illuminated by green light, while the pixels on the right side of pixels 114 in the row are illuminated by the red colour light. For the pixels in row p, pixel 118 has an undeterminable colour, while the other pixels of the row are illuminated by the red colour light. As the colour wheel spins during operation, the boundary sweeps across the pixel rows over time; and the pixel rows change from one colour to another. The slope of the boundary also varies from the top to the bottom of the pixel array. Specifically, the slope of the boundary at the top of the pixel array is greater than the slope of the boundary at the bottom of the pixel array, though this depends upon the orientation of the light modulator to the spokes of colour wheel.

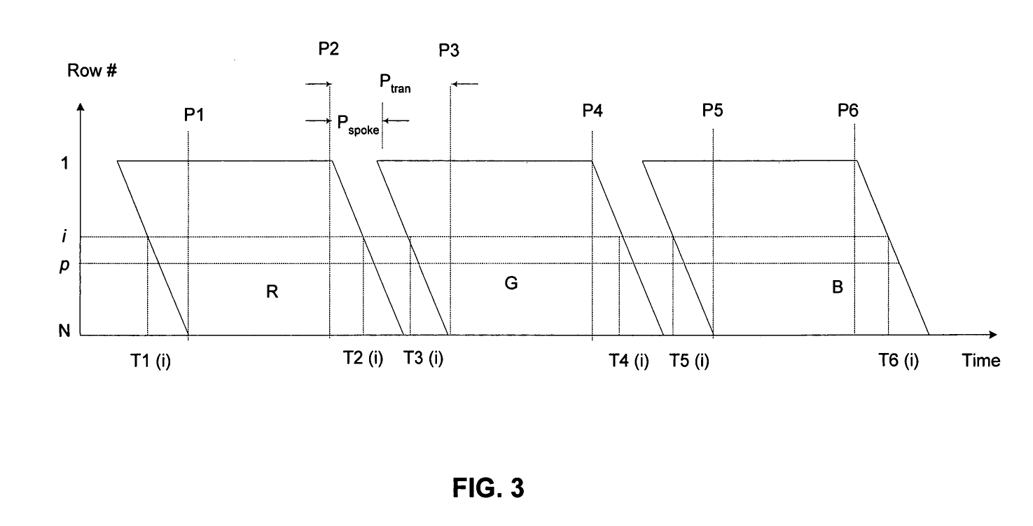

Referring to FIG. 3, an exemplary illumination scheme for the pixel array in the light modulator is illustrated therein. The rows of the pixel array of the light modulator are plotted in the Y-axis; and the time is plotted in the X-axis. Primary colour light beams red, green, and blue sequentially illuminate the pixel array of the light modulator during each frame period. In this particular example, primary colours red, green, and blue are produced to illuminate the pixels of the light modulator. Other colours, such as yellow, cyan, and magenta colours may also be used if the segments of colour wheel are designed accordingly.

According to the invention, a frame period is divided into primary colour periods and colour transition periods, each colour transition period further comprising a set of spoke periods. During a primary colour period, the pixels of the light modulator are illuminated by one primary colour. As shown in FIG. 3, time intervals from P₁ to P₂, from P₃ to P₄, from P₅ to P₆ are primary colour periods. Time intervals from P₂ to P₃, and P₄ to P₅ are colour transition periods, during each of which a combination of primary colours sweep across the pixel array from row 1 to row N. Specifically, during the colour transition period from P₂ to P₃, a combination of red and green colours sweeps across the rows of the pixel array from row 1 to row N. During the colour transition period from P₄ to P₅, a combination of green and blue colours sweeps across the rows of the pixel array from row 1 to row N. Because the combination of the primary colours has a defined boundary when illuminates the pixels of the light modulator, such a boundary sequentially sweeps across the rows of the pixel array of the light modulator during a colour transition period. Accordingly, a spoke period can be defined for a row of pixels as the time interval that the row of pixels is swept by a spoke. The spoke periods within a colour transition period vary with positions of the rows. Specifically, the spoke periods within a colour transition period for different rows start and end at different times, and the duration of the spoke periods may change with the rows. For example, for the i^{th} row, the spoke period is from T₂(i) to T₃(i). For the (i+1)^{th} row, the spoke period of this row starts from T₂(i+1), which is one unit time behind T2(i); and the spoke period of this row ends at T₃(i+1), which is one unit time behind T₃(i).

With such sequential colour light beams, the present invention provides a modulation algorithm for modulating the light shining on the pixels of the light modulator so as to displaying colour images. Specifically, during each primary colour period (e.g. periods from P₁ to P₂, P₃ to P₄, and P₅ to P₆), the primary colour light beam is modulated by the pixels of the light modulator using a pulse-width-modulation technique, such as a binary weighted pulse-width-modulation technique. The modulation can be performed for all pixels at a time of the array by writing the memory cells of the pixels with the corresponding image data. Alternatively, the modulation can also be performed by writing the corresponding image data to the rows of the array sequentially. In performing pulse-width-modulation, artifacts, such as colour separation and/or dynamic false contour may be generated. To avoid these artifacts, the pixels in each row of the array or the rows of pixels can be updated at different time intervals, as set forth in U.S. patent application Ser. No. 10/407,061 to Richards, filed Apr. 2, 2003, the subject matter being incorporated herein by reference.

During the colour transition periods, even though some pixel rows (e.g. rows from i to p) are illuminated by a combination of primary colours, the other pixel rows (e.g. rows from 1 to i and from p to N) are still illuminated by only one primary colour. Therefore, these rows of pixels illuminated by only one primary colour can keep on modulating the primary colour. Because the pixels of these rows experience colour transitions at different times, light modulation by these pixels is scheduled at different times. For example, during the primary colour period from P₁ to P₂, the pixels of the i^{th} row modulate the red light beam using a pulse-width-modulation technique. During the time interval from P₂ to T₂(i), the pixels in the i^{th} row keep on modulating the red colour light beam. At T₂(i), the pixels of the i^{th} row can be set to the OFF state till T₃(i). At T₃(i), the pixels of the i^{th} row are illuminated by the green colour light only. Therefore, the pixels of the i^{th} row start to modulate the green light using the pulse-width-modulation method till time P₃. During the primary colour period from P₃ to P₄, the pixels of the i^{th} row may perform the pulse-width-modulation along with all other pixels of the array.

The modulation algorithm for the pixel of the i^{th} row as discussed above are applied to other pixels. For example, during the primary colour period from P₁ to P₂, the pixels of the (i+1)^{th} row modulate the red light beam using a pulse-width-modulation technique. During the time interval from P₂ to T₂(i+1) that is one unit time later than T₂(i), the pixels in the (i+¹)^{th} row keep on modulating the red colour light beam. At T₂(i+1), the pixels of the (i+1)^{th} row can be set to the OFF state till T₃(i+1). It is clear that, the pixels of the (i+1)^{th} row are set to the OFF state at a time one unit time later than the pixels of the i^{th} row, but set to the OFF state for the same time interval. At T₃(i+1), the pixels of the (i+1)^{th} row are illuminated by the green colour light only. Therefore, the pixels of the (i+1)^{th} row start to modulate the green light using the pulse-width-modulation method till time P₃.

In the above discussed examples, all pixels of the rows in the spoke periods are set to the OFF state, such as the pixels in rows from i to p in FIG. 2E. Alternatively, the individual pixels having a single primary colour may also be operated to modulate primary colours. Referring back to FIG. 2E, pixels 113 in row i illuminated by green colour can modulate the green colour light beam with the corresponding image data, while pixels 112 are set to the OFF state. For row m, pixels 115a and 115b are respectively illuminated by green and red colours. Accordingly, pixels 115a and 115b may modulate the green and red colours respectively, while pixels 114 are set to the OFF state. Since pixels 117 in row p are illuminated by the red primary colour, these pixels may modulate the red light beam with the corresponding image data. Pixel 118 is set to the OFF state. It can be seen that, this modulation algorithm best utilizes the illumination colour by individually blanking (setting to the OFF state) the pixels having uncertain or mixed colours.

It can be seen from the figure and the modulation algorithm as discussed above that, the modulation algorithm of the present invention utilizes all primary light beams that are not combined with the other primary colours. This certainly improves the optical efficiency and brightness of the displayed image without sacrificing colour saturation.

It will be appreciated by those of skill in the art that a new and useful method and apparatus for illuminating light modulators of display systems have been described herein. In view of the many possible embodiments to which the principles of this invention may be applied, however, it should be recognized that the embodiments described herein with respect to the drawing figures are meant to be illustrative only and should not be taken as limiting the scope of invention. For example, those of skill in the art will recognize that the illustrated embodiments can be modified in arrangement and detail without departing from the spirit of the invention. Therefore, the invention as described herein contemplates all such embodiments as may come within the scope of the following claims and equivalents thereof.

We claim:

1. A display system, comprising:
a light source providing light;
a lightpipe positioned in the propagation path of the light;
a colour wheel comprising a set of colour filtering segments and being positioned in the propagation path and after the lightpipe, said segments being sized such that at most two different colours are incident on a set of pixels of a light modulator at a time; and
wherein the light modulator is positioned in the propagation path and modulating the light so as to produce an image.

2. The system of claim 1, wherein the lightpipe comprises a hollow cavity for recycling light reflected from the segments of the colour wheel.

3. The system of claim 2, wherein the segments of the colour wheel comprise dichroic coatings.

4. The system of claim 1, wherein colour wheel comprises at least three segments that respectively pass red, green, and blue colour bands.

5. The system of claim 4, wherein the colour wheel comprises a segment that is transmissive to visible light.

6. The system of claim 4, wherein the number of the segments of the colour wheel is equal to, or less than 12.

7. The system of claim 1, wherein the light modulator comprises pixels operable between an ON and OFF state, the pixels reflecting the light on to a display target in the ON state and the light modulator reflecting the light away from the display target in the OFF state.

8. The system of claim 7, wherein the light modulator comprises an array of individually addressable and deflectable micromirrors.

9. The system claim 8, wherein the states of the micromirrors correspond to the colour bands passing the segments of the colour wheel.

10. A method for displaying an image, comprising:
emitting light from a light source;
a lightpipe collecting the light and projecting the collected light onto a set of colour filtering segments of a colour wheel so as to illuminate an area on the colour wheel, wherein each said segment being sized such that at most one boundary of adjacent segments appears in the illuminated area on the colour wheel at a time;
illuminating an array of pixels of a light modulator with the light passing through the segments of the colour wheel such that at most two colours are incident on the pixel array; and
modulating the colours with the pixels of the pixel array with corresponding image data.

11. The method of claim 10, further comprising:
producing a sequence of colour light during a frame period, said frame period comprising: a sequence of primary colour periods and a sequence of transition periods each of which is positioned between two consecutive primary colour periods, wherein each transition period comprises a sequence of spoke periods each of which is associated with a row of pixels such that pixels in different rows of the array have are associated with different spoke periods.

12. The method of claim 11, further comprising:
modulating the sequence of coloured light during the primary colour periods with image data corresponding to the primary coloured light; and
modulating the sequence of coloured light during the spoke periods such that different rows modulate the coloured light at different spoke time periods.

13. The method of claim 11, further comprising;
during the spoke periods, turning the pixels to an OFF state, in which state the primary colour light is reflected away from a display target.

14. The method of claim 11, wherein the sequence of colour light comprises red, green, and blue colour light.

15. The method of claim 11, wherein the sequence of colour light comprises yellow, cyan and magenta.

16. An illumination system for illuminating a light modulator having an array of pixels of a display system, comprising:
a light source providing light;
a lightpipe for collecting the light and projecting the collected light onto a colour wheel that comprises 12 or fewer colour filtering segments with radially extending borders between the segments; and
wherein the colour wheel is positioned between the light modulator and the lightpipe.

17. The system of claim 16, wherein the colour wheel has segments that respectively pass red, green, and blue colour bands.

18. The system of claim 17, wherein the colour wheel has a segment that passes the light from the light source.

19. The system of claim 16, wherein the lightpipe illuminates an area on the colour wheel, said illuminated area having a size equal to or less than a total size of adjacent segments.

20. The system of claim 17, wherein each segment has a straight edge along the radius of the colour wheel:

21. An illumination system for illuminating a light modulator having an array of pixels of a display system, comprising:
a light source providing light;
a lightpipe for collecting the light and projecting the collected light onto a colour wheel that comprises a set of colour filtering segments, each said segment having an edge along a radius of the colour wheel; and
wherein the colour wheel is positioned between the light modulator and the lightpipe.

22. A method of displaying an image using a light modulator that comprises an array of pixels, comprising:
illuminating the array of pixels with a sequence of coloured light, wherein at most two colours are present on the pixel array in a first colour area and a second colour area at a time; and
modulating the coloured light with the pixels such that within a row at least one pixel is within the first colour area and modulates light of a first colour, and a second pixel is within the second colour area and modulates light of the second colour, and a third pixel is positioned between the first and second pixels and modulate light in way different from the first and second pixels.

23. The method of claim 22, further comprising:
producing the sequence of colour light during a frame period, said frame period comprising: a sequence of primary colour periods and a sequence of transition periods each of which is positioned between two consecutive primary colour periods, wherein each transition period comprises a sequence of spoke periods each of which is associated with a row of pixels such that pixels in different rows of the array have are associated with different spoke periods;
modulating the sequence of colour light during the primary colour periods with image data corresponding to the primary colour light; and
modulating the sequence of colour light during the spokes such that different rows modulate the colour light at different spoke time periods.

24. The method of claim 22, wherein sequence of colour light comprises red, green and blue primary colour light.

25. The method of claim 23, wherein the step of modulating the sequence of colour light during the spoke time periods further comprises:
turning the pixels of the rows in the spoke periods to an OFF state, in which state the sequence of colour light is reflected away from a display target.

26. The method of claim 23, wherein the step of producing the sequence of colour light further comprises:
emitting light from a light source;
guiding the light from the light source to a colour wheel by a lightpipe, wherein the colour wheel comprises a set of colour segments, each segment passing a particular waveband of the primary colour; and
passing the light from the lightpipe onto the colour wheel as the colour wheel is spinning.

27. The method of claim 26, wherein the step of passing the light from the lightpipe onto the colour wheel further comprises:
synchronizing the spinning of the colour wheel to the modulation of the sequence of colour light.
